(19) United States
(12) Patent Application Publication
(10) Pub. No.: US 2016/0217528 A1
(43) Pub. Date: Jul. 28, 2016

(54) Displaying a Market Trend Using a Graphical Indicator

(71) Applicant: TRADING TECHNOLOGIES INTERNATIONAL INC., Chicago, IL (US)

(72) Inventors: Gerald J. O'CONNOR, Wilmette, IL (US); Simon TAM, Point Roberts, WA (US); Richard FRIESEN, Fairfax, CA (US)

(21) Appl. No.: 14/607,836

(22) Filed: Jan. 28, 2015

(51) Int. Cl. G06Q 40/04

(52) U.S. Cl. CPC G06Q 40/04

(57) ABSTRACT

Example methods, systems, and computer-readable media to indicate a market trend using a graphical indicator are disclosed herein. An example method includes displaying price levels of a tradeable object on a trading interface. The trading interface is to be used to execute trades via an electronic exchange. The example method also includes monitoring a price and a volume of trades of the tradeable object. The example method further includes displaying a graphical indicator on the trading interface to indicate a trend between the volume of trades and the price.

### BACKGROUND

An electronic trading system generally includes a trading device in communication with an electronic exchange. The electronic exchange sends information about a market, such as prices and quantities, to the trading device. The trading device sends messages, such as messages related to orders, to the electronic exchange. The electronic exchange attempts to match quantity of an order with quantity of one or more contra-side orders.

The trading device may provide a trading interface to enable a user to monitor the information about the market and execute trades via the electronic exchange. Some trading interfaces list prices, bid quantities and/or ask quantities of a tradeable object to enable the user to determine a market depth of the tradeable object.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIGS. 4A to 4E illustrate examples trading interface which may be used to implement the disclosed embodiments.

FIG. 5 illustrates an example graphical indicator indicating a first market trend.

FIG. 6 illustrates the example graphical indicator of FIG. 5 updated to indicate a second market trend.

FIG. 7 illustrates the example graphical indicator of FIGS. 5-6 updated to indicate a third market trend.

FIG. 8 illustrates the example graphical indicator of FIGS. 5-7 updated to indicate a fourth market trend.

FIG. 9 illustrates the example graphical indicator of FIGS. 5-8 updated to indicate a fifth market trend.

FIG. 10 illustrates the example graphical indicator of FIGS. 5-9 updated to indicate a sixth market trend.

FIG. 11 illustrates an example menu disclosed herein, which may be used to adjust a characteristic and/or feature of the example graphical indicator of FIGS. 5-10.

FIG. 12 illustrates the example graphical indicator of FIGS. 5-10 employing patterns to indicate another market trend over a first window of time.

FIG. 13 illustrates the example graphical indicator of FIG. 12 updated to indicate the market trend over a second window of time.

FIG. 14 illustrates the example graphical indicator of FIGS. 12-13 updated to indicate the market trend over a third window of time.

FIGS. 15 and 16 illustrate an example trading interface including an example layered graphical indicator indicating market trends.

FIG. 17 illustrates another example graphical indicator disclosed herein.

FIG. 18 illustrates yet another example graphical indicator disclosed herein.

FIG. 19 is a flow diagram representative of an example method disclosed herein to indicate a market trend using a graphical indicator.

FIG. 20 is a flow diagram representative of another example method disclosed herein to indicate a market trend using a graphical indicator.

FIG. 21 illustrates a block diagram of an example trading interface module that may be used to implement and/or execute the example method of FIG. 19 and/or the example method of FIG. 20.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

This patent disclosure relates generally to electronic trading environments and, more particularly, to indicating a market trend using a graphical indicator.

Methods, systems and computer readable media to indicate a market trend using a graphical indicator are disclosed herein. A trading interface may be provided by a trading device to enable a user to monitor market data related to a tradeable object, execute trades of the tradeable object and/or perform other actions. In some examples, prices of the tradeable object, ask quantities, bid quantities and/or other information are displayed on the interface to enable the user to view the inside market as well as the market depth of the tradeable object. As the tradeable object is traded on the market, the market depth of the tradeable object may change. The price of the tradeable object may increase, decrease, fluctuate or be substantially constant while the volume of trades of the tradeable object increases, decreases, fluctuates, or is substantially constant. A relationship between the price and the volume of the tradeable object may influence whether the user executes a trade. For example, if the user detects that the price and the volume of trades are decreasing, the user may go short. The example trading interfaces disclosed herein include a graphical indicator to indicate a trend between the price and the volume, thereby enabling the user to visually detect the relationship between the price and the volume of trades of the tradeable object. The example graphical indicators disclosed herein are updated (e.g., substantially continuously or periodically) based on market data communicated to the trading device to enable the graphical indicator to indicate the trend on a rolling or up-to-date basis.

In some examples, the graphical indicator is an object or icon such as an arrow, which is displayed on the trading interface. In other examples, the graphical indicator is formed by components of the trading interface such as, for example, lines, areas, text and/or any other components.

In some examples, the graphical indicator indicates the volume of trades of the tradeable object using one or more colors, shadings, patterns and/or other indicators. For example, if the volume is changing, the graphical indicator may include a color gradient extending from one end to another end of the graphical indicator to indicate a direction in which the volume is increasing (e.g., increasing or decreasing) and/or an amount of change of the volume of trades. If the volume plateaus, for example, at a given price, the graphical interface may be updated to be a single color. If the volume is fluctuating between two values, the graphical indicator may be updated to change back and forth between two colors. In some examples, the graphical indicator includes a list of prices or price levels. In some such examples, shading, colors, patterns and/or other indicators adjacent each of the prices or price levels indicates the volume at the prices or price levels. In some examples, the trading interface includes prices or price levels overlaying the graphical indicator.

In some examples, the graphical indicator indicates a level of volume of trades of the tradeable object. The level of volume is the volume of trades relative to a reference volume such as a median or average volume over a period of time. The graphical indicator enables a user to visually detect abnormal or exceptional volumes at which the tradeable object is being traded on a market. In some examples, the graphical indicator indicates the level of volume of trades at each of a plurality of prices or price levels. For example, the graphical indicator may indicate that a high volume level of trades occurred at a first price level (e.g., 5 ticks below the inside market) and a low volume level of trades occurred at a second price level (e.g., 1 tick above the inside market).

In some examples, an orientation of the graphical indicator indicates a direction of change of the price. For example, if the graphical indicator is an arrow, the graphical indicator may point in a direction associated with the direction of change of the price. For example, if the price is increasing, the arrow may point upwards and/or toward a highest price listed in the trading interface. If the price is decreasing, the arrow may point downwards and/or toward a lowest price listed in the trading interface.

In some examples, a size of the graphical indicator indicates a rate of change of the price of the tradeable object. For example, if the rate of change of the price is increasing, the graphical indicator may be updated to increase a size of the graphical indicator. As a result, the user may perceive the graphical indicator to be growing and, thus, quickly and easily recognize that the price is increasing or decreasing at an increasing rate of change.

In some examples, the graphical indicator indicates the market trend over one or more windows of time. For example, the graphical indicator may indicate the market trend for a period of time leading up to and/or including a current time at which the trading device is being used by the user to monitor the market data, execute one or more trades, etc. For example, in a fast moving market, the graphical indicator may indicate the market trend over an eight second period of time ending with the current time. In some examples, the graphical indicator indicates the market trend over a price range. For example, the graphical indicator may indicate a relationship between the price and the volume of trades over a recent or current price move (e.g., over a latest fifteen ticks of movement of the price of the tradeable object).

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. Brief Description of Certain Embodiments

Methods, systems and computer readable media to indicate a market trend using a graphical indicator are disclosed herein.

An example method disclosed herein includes determining a first volume of trades of a tradeable object and determining a first direction of a change of a price of the tradeable object. The example method also includes generating a graphical indicator via a trading device based on the first volume and the first direction of the change of the price. The graphical indicator is to visually indicate a first level of volume of the tradeable object associated with the first direction of the change of the price. The example method further includes displaying the graphical indicator with respect to a trading interface including market data related to trades of the tradeable object.

An example tangible computer readable storage medium disclosed herein includes instructions that, when executed, cause a computing device to monitor a volume of trades and a price of a tradeable object. The example tangible computer readable storage medium also includes instructions that, when executed, cause the computing device to monitor a price of the tradeable object, detect a change of the price of the tradeable object, and update a graphical indicator based on the volume and the change of the price to visually indicate a relationship between the volume and the change of the price. The example tangible computer readable storage medium also includes instructions that, when executed, cause the computing device to display the graphical indicator with respect to a trading interface including market data related to trades of the tradeable object.

Another example method disclosed herein includes displaying price levels of a tradeable object on a trading interface. The trading interface is to be used to execute trades via an electronic exchange. The example method also includes monitoring a price and a volume of trades of the tradeable object. The example method further includes displaying a graphical indicator on the trading interface to indicate a trend between the volume of trades and the price.

### II. Example Electronic Trading System

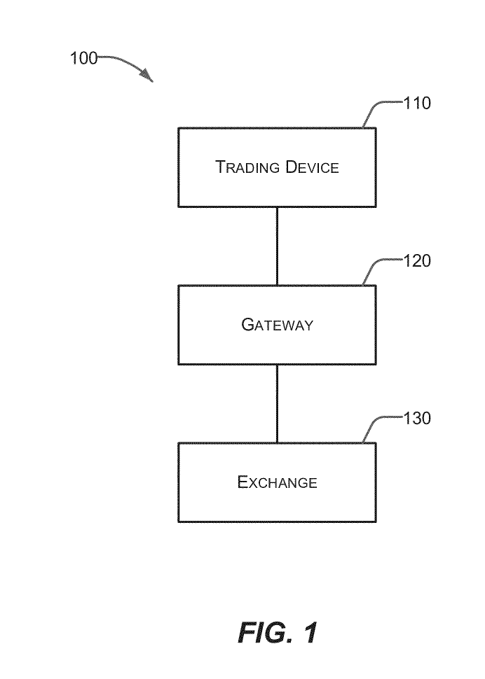

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market.

The price levels associated with the inside market and market depth can be provided as value levels which can encompass prices as well as derived and/or calculated representations of value. For example, value levels may be displayed as net change from an opening price. As another example, value levels may be provided as a value calculated from prices in two other markets. In another example, value levels may include consolidated price levels.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange, a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object; a command to initiate managing orders according to a defined trading strategy; a command to change, modify, or cancel an order; an instruction to an electronic exchange relating to an order; or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. Once an order to buy or sell a tradeable object is received and confirmed by the exchange, the order is considered to be a working order until it is filled or cancelled. If only a portion of the quantity of the order is matched, then the partially filled order remains a working order. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

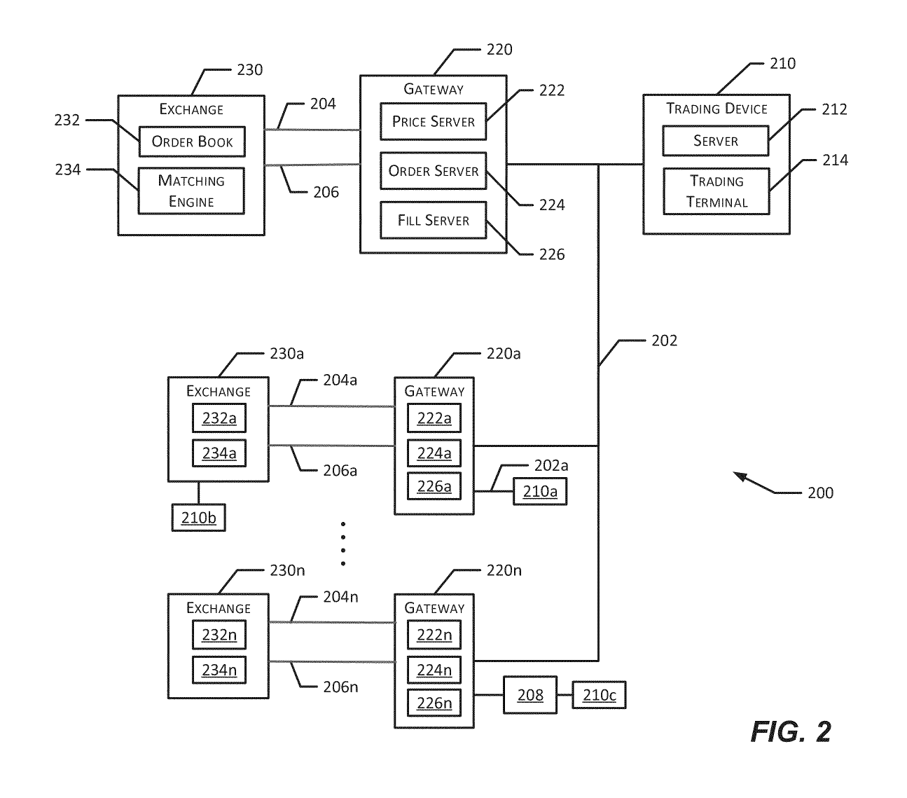

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. Example Computing Device

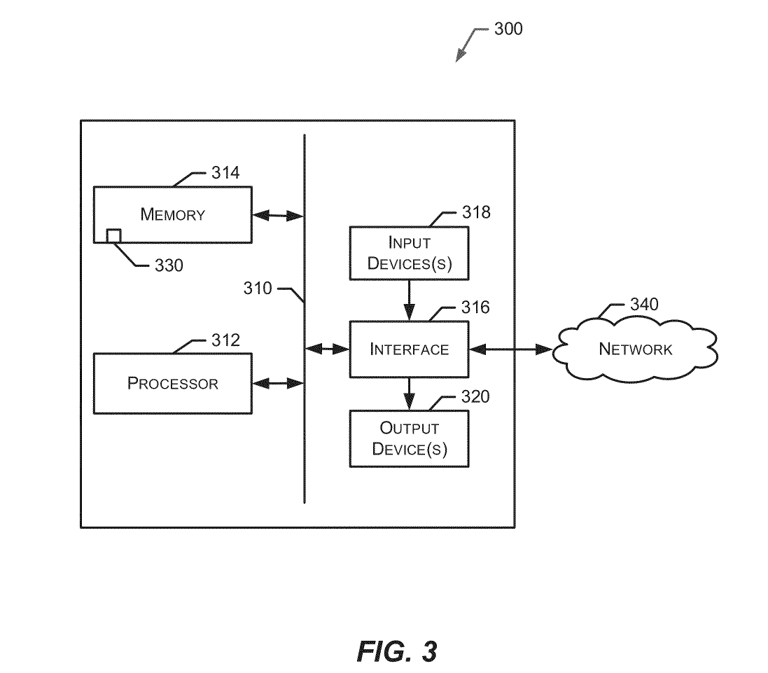

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Trading Interface

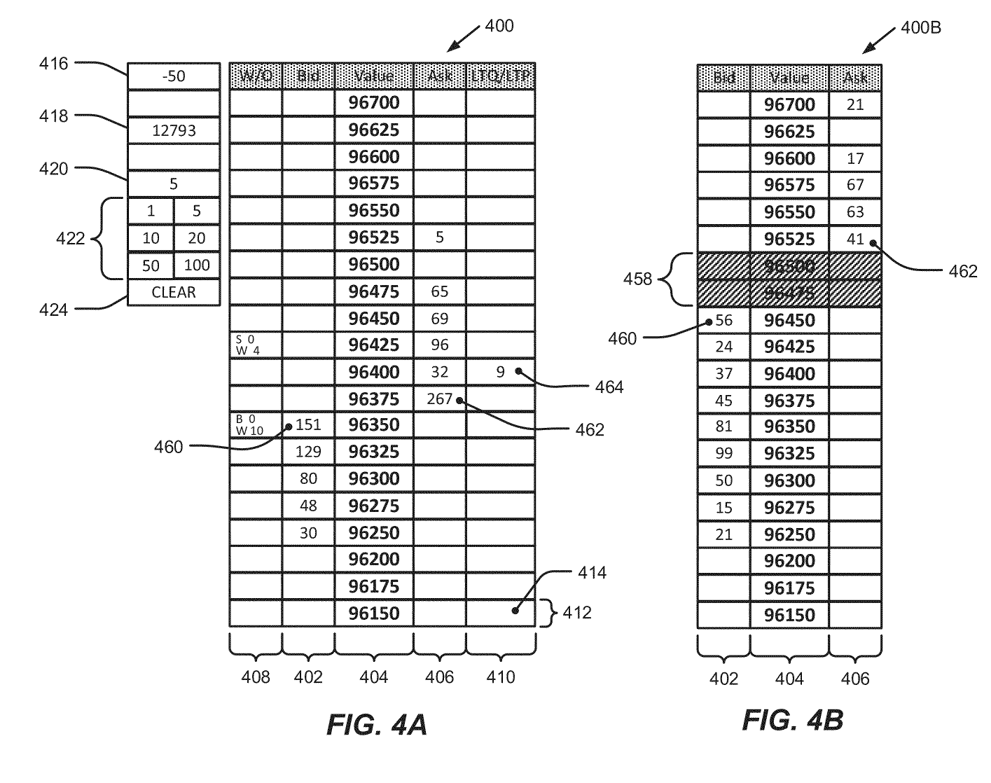

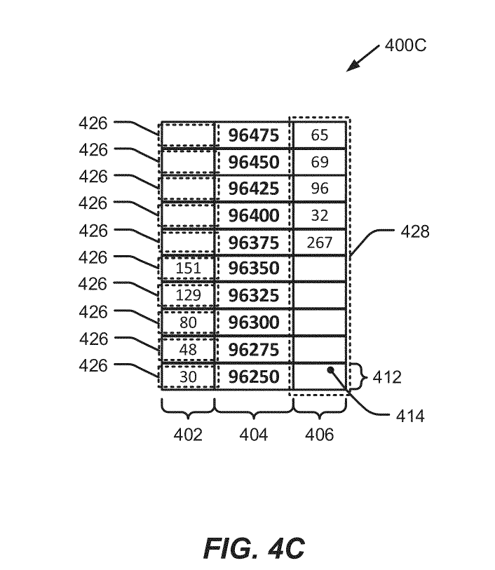

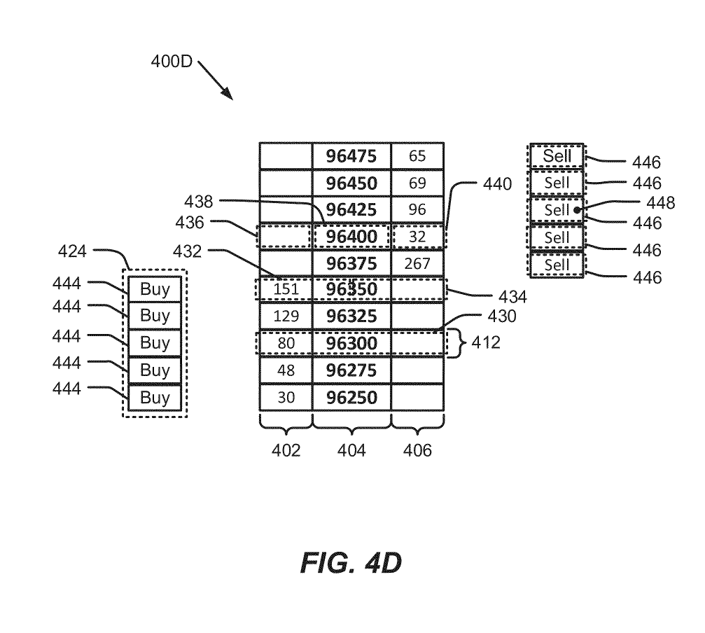

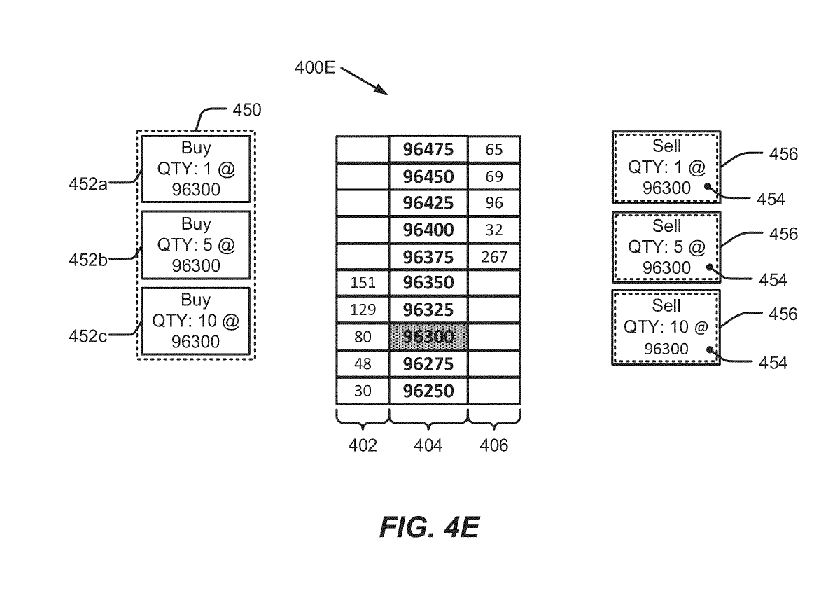

FIG. 4A illustrates an example trading interface 400 in which certain embodiments may be employed. The example trading interface 400 shows market data for a tradeable object at a first point in time. While the following examples are described in conjunction with the example electronic trading system 200 of FIG. 2, the examples disclosed herein may be implemented in other electronic trading systems, such as the example trading system 100 of FIG. 1.

As described above in conjunction with FIG. 2, the trading device 210 receives market data related to one or more tradeable objects from the exchange 230 and/or the exchanges 230a-230n through the gateway 220 and/or the gateways 220a-220n, respectively. The trading device 210 provides a trading application including trading tools to process and/or organize the market data and provide the example trading interface 400. Trading tools include, for example, MD TRADER®, X_TRADER®, ADL®, AUTOSPREADER®, and AUTOTRADER™, each provided by Trading Technologies. The trading device 210 provides the trading interface 400 to enable a user to view market data and communicate trade orders and trade actions with an electronic exchange.

In the illustrated example of FIG. 4A, the trading interface 400 includes a bid column 402, a value column 404, and an ask column 406. The trading interface 400 further includes a working order (W/O) column 408 and a last traded quantity (LTQ)/last traded price (LTP) column 410. The trading interface 400 may include other columns such as an estimated position in queue (EPIQ) column, a single combined bid/ask column, a user-defined indicator column, an inside market indicator column, and/or any other column for providing indicators. The trading interface 400 also includes rows such as row 412. The columns intersect with the rows to define cells such as cell 414. In other embodiments, different orientations other than vertical columns may be used (e.g., horizontal and diagonal arrangements).

In the illustrated example, bid indicators representing the bid quantities of the tradeable object are displayed in the bid column 402, value indicators corresponding to value levels are displayed in the value column 404, and ask indicators representing the ask quantities of the tradeable object are displayed in the ask column 406. A bid quantity is a quantity available on the bid side of the tradeable object at a given value level. The value levels can be configured to represent prices, net change, derivatives of price, consolidated prices, synthetic tradeable object pricing, spread pricing, and/or other representations of value. The ask quantity is a quantity available on the ask side of the tradeable object at a given value level. The indicators are not limited to numerical values and can include any type or combination of indicator or symbol to illustrate the presence of available quantity without providing a specific numeric value. For example, the indicators may include text, icons, colors, lines, and/or other graphical representations. In one example, the indicators may represent a range of quantity available at particular value levels in place of specific, and frequently changing, quantity values. In another example, the relative size of indicators may proportionally represent the quantity available. In another example, the indicators may represent simply that there is quantity available with no illustration of the amount in excess of zero.

Trading interfaces, such as the trading interface 400, may include indicators to identify the inside market. The inside market indicators may utilize multiple representations to identify the highest bid price and the lowest ask price. The inside markets indicators may also include additional information such as information related to quantities at the inside market. Examples of inside market indicators include a best bid price indicator representing the highest available bid price, a best ask price indicator representing the lowest available ask price, and/or an indicator representing a range between the highest available bid price and the lowest available ask price. As shown in FIG. 4B, the inside market indicator may highlight and identify the range 458 of value levels between the highest available bid price of “96450” and the lowest available ask price of “96525”. Inside market indicators may be displayed within the trading interface to identify specific value level(s) in the value column 404. For example, a best bid price indicator may be displayed in a cell containing a bid quantity indicator and corresponding to a value level that reflects the best bid price. As another example, a best ask price indicator may be a color or symbol combined with an ask quantity indicator in the ask column 406 in a cell corresponding to a value level that reflects the best ask price. As another example, inside market indicators may be displayed at value levels within the value column 404 that reflect the best bid price and the best ask price. The inside market indicators can include any type or combination of indicator or symbol (e.g., the indicators may include text, icons, colors, lines, and/or other graphical representations).

In certain embodiments, the inside market indicators may be provided by the presence of a quantity indicator. The presence of a quantity indicator refers to the existence and location of the quantity indicator. For example, the presence of the best bid quantity indicator, independent of the quantity value displayed at any given point in time, in the bid column may be the best bid price indicator. Thus, the existence of a quantity indicator at the highest value level in the bid column is the best bid price indicator. To be clear, in this example, the value of the bid quantity indicator is not part of the best bid price indicator. Rather, the existence of the bid quantity indicator itself at the highest value level in the bid column is the best bid price indicator. In other words, the display of the highest bid quantity indicator is the best bid price indicator. As shown in FIG. 4A, the presence of the bid quantity indicator “151” at the highest value level in the bid column at the price of “96350” is the best bid price indicator 460. Similarly, the presence of the ask quantity indicator “267” at the lowest value level in the ask column at the price of “96375” is the best ask price indicator 462.

From the user's perspective, the trading interface 400 may present and display indicators, such as inside market and LTP/LTQ indicators, in a manner that conveys the appearance of movement relative to the value column 404. For example, the manner in which the trading interface alters the position of the best bid price indicator and the best ask price indicator relative to the value levels within the value column may allow the user to perceive changes in both the speed and direction of trading within a market. The trading interface 400 updates based on received market data. For example, the trading interface 400 moves the best bid price indicator 460 relative to the value column 404 when the received market data includes a quantity at a new highest bid price. As another example, the trading interface 400 moves a LTP indicator 464 (shown in the LTQ column 410 of FIG. 4A) relative to the value column 404 when the received market data includes a new last traded price.

The trading interface 400 shown in FIG. 4A depicts and identifies the inside market via the best bid price indicator 460 aligned with the highest available bid price and the best ask price indicator 462 aligned with the lowest available ask price at a first point in time. For example, the best bid price indicator 460 is moved to reflect the change in the best bid price from “96350” (FIG. 4A) to “96450” (FIG. 4B). Similarly, the best ask price indicator 462 is moved to reflect the change in the best ask price from “96375” to “96525”. By observing the movement of the inside market indicators relative to the value column 404 in the described manner, the user can quickly perceive that the market is trading higher.

Moreover, as illustrated in the trading interface 400 shown in FIG. 4A, the bid quantity indicator “151” is at the best bid price “96350” and the ask quantity indicator “267” is at the best ask price “96375”. At the second point in time, the displayed quantity indicators are updated to reflect new quantities available. As shown in FIG. 4B, the bid quantity indicator “56” is at the best bid price “96450” and the ask quantity indicator “41” is at the best ask price “96525”. Although the quantity values have changed, it is the presence of the bid quantity indicator at the highest value level in the bid column and the presence of the ask quantity indicator at the lowest value level that are the inside market indicators.

From the user's perspective, indicators may appear to move relative to the value column 404. This appearance of movement may result from painting an indicator in a new location on the trading interface 400 or painting over to remove an indicator from the trading interface 400. Painting may include drawing on a surface, multilayer compositing, or other rendering techniques. For example, in the bid column 402, painting a new quantity indicator above the current best bid quantity indicator creates the appearance of upward movement to inform the user that the market has moved. In another example, in the ask column 406, painting over the best ask quantity indicator to remove it from the trading interface 400 results in the appearance of upward movement in the market. As another example, other indicators such as the LTP indicator 464 can appear to move relative to the value column 404 using these techniques.

The movement of the indicators relative to the value column 404 may be implemented in a variety of ways. In certain embodiments, movement of an indicator includes repositioning the indicator from one location to another location. For example, the best bid price indicator may be a graphical user interface element or object, such as a line, shape, arrow, or sprite, the on-screen position of which is changed to a new location representing a new best bid price. In certain embodiments, movement of an indicator includes removing the indicator at one location and replacing it with a new indicator at another location, which as user may perceive as the appearance of movement. For example, the best bid price indicator may be a yellow background color for a cell in the value column 404. When the best bid price changes, the background color for the cell is changed to default color (e.g., black) and the background color of a second cell associated with the new best bid price is changed to yellow to provide the new best bid price indicator. In certain embodiments, the object representing the best bid price indicator may change from one location to another location. For example, the value, color and/or shape of the best bid price indicator may change from one location to another location.

When quantity information is displayed in relation to the value column 404 and the market moves up or down, the inside market indicators can be said to “move” up or down from the user's perspective in relation to the value column 404 to reflect a new highest bid price or a new lowest ask price. For example, when the quantity indicators are represented with numerical values and the inside market indicators are provided by the presence of the highest bid quantity indicator and lowest ask quantity indicator, the exact numeric value representing the quantity at the best bid price or the best ask price need not move or provide the appearance of movement. The quantity indicators, in this particular example, at those particular price levels may have changed, but they do not actually move—it is the best bid indicator that has “moved.”

The value indicators in the value column 404 may be repositioned. A selected value indicator may be repositioned to a designated location and other value indicators are repositioned relative to the selected value indicator. The selected value indicator may be based on, for example, a user selection or market related values such as the highest bid price or lowest ask price, LTP, and a calculated average of the best bid and best ask prices. The designated location may be a pre-determined location or a location defined by a user. In one configuration, in response to the repositioning command, the selected value indicator may be moved to the designated location corresponding to the middle of the display (e.g., to a location corresponding substantially to the midpoint of the length of the value column 404). In another configuration, in response to the repositioning command, the selected value indicator can be displayed at a user-identified or pre-defined position within the display. From a user's perspective, repositioning is the appearance of movement of values in the value column 404 to new locations in the value column 404. This appearance of movement may result from repainting the values in the value column 404.

The value indicators in the value column 404 may be repositioned in response to various commands or triggering conditions. In one example, the value indicators displayed in the value column 404 may be repositioned in response to a triggering condition. Some examples of a triggering condition include: a user input; expiration of an alarm or timer; a determination that the inside market is, or may be, moving off the display; a determination that the inside market has exceeded an upper threshold or a lower threshold; an event in another trading interface; a market event relating to the same or a different tradeable object; a user-defined event; and/or a determination that a value exceeds a threshold.

In some examples, an indicator based on market data (such as best bid, best ask, LTP) may be displayed at the same fixed location in the trading interface 400. For example, the best bid indicator in the bid column 402 may be displayed at a specified fixed location. The fixed location may be pre-determined or defined by a user. For example, the best bid indicator and/or the best ask indicator may, for example, be maintained at the center of the display, at the top of the display, at the bottom of the display or any designated location.

In the illustrated example, the values, which are prices, are displayed without decimal points (which may be a format or convention expected by a user) and in descending order from a top to a bottom of the value column 404 in the orientation of FIG. 4A. In other examples, the prices are listed in other orders (e.g., ascending order from top to bottom) and/or formats (e.g., with decimal points, fractions, in scientific notation, and/or any other format).

In the illustrated example, the indicators in the bid column 402 and the ask column 406 are updated to indicate quantity changes at each value level identified along the value column 404. For example, values of the ask quantities and/or the bid quantities may increase or decrease due to order quantities being added, deleted or matched at each value level. The indicators may be updated based on a timer and/or in response to new data being received, for example.

In some examples, the trading interface 400 includes additional and/or different information. In the illustrated example, the trading interface 400 also displays a net price change 416 of the tradeable object over a given amount of time (e.g., since the market opened on a given day). The trading interface 400 also includes a total volume 418 of the tradeable object (e.g., a number of lots that have been traded). Other embodiments may include different and/or additional information.

The trading interface 400 also enables the user to specify parameters for a trade order. In the illustrated example, the trading interface 400 includes a quantity field 420. The quantity field 420 displays a quantity (e.g., 5) for an order that the user will send to market, and the user may adjust the quantity by selecting (e.g., via a mouse) one of a plurality of buttons 422 adjacent the quantity field 420 or entering a new value into the quantity field 420. If the user selects a button 424 labeled “CLEAR” in the illustrated example, the quantity field 420 is cleared (e.g., the quantity displayed in the quantity field 420 is adjusted to be zero).

The trading interface 400 further enables the user to enter an order to buy or sell a tradeable object via an order entry area configured to receive a selection and in response initiate placement of the order. Selection of an order area may be by a single action of an input device such as a single click, a double click, or a multi-touch gesture. Initiating placement of an order may include preparing a message to send an order to an exchange or sending an order to an electronic exchange. The trading interface 400 may include multiple order entry areas. The trading interface 400 may request that a user confirm an order to be placed prior to sending it.

Order entry areas may overlap or encompass one or more regions of a trading interface. For example, an order entry area may overlap all or part of the cells making up a row. As another example, an order entry area may overlap all or part of the cells in a column such as the bid column, ask column or value column. In another example, an order entry area may overlap a cell and a region outside of the cell. In certain embodiments, a trading interface may include a first order entry area overlapping first cell and a second order entry area overlapping a second cell. In certain embodiments, a first order entry area overlaps a first cell and a portion of a second cell, and a second order entry area overlaps a portion of the second cell and a third cell. In certain embodiments, order entry areas may encompass other regions of the trading interface.

Each order entry area may align with a value level. For example, an order entry area may be aligned with one of the value levels making up the value column 404. In another example, an order entry area may be independent of and not aligned with a value level.

An order entry area may be linked to other elements of the trading interface 400. For example, an order entry area may be linked to a particular value level making up a value column by specifying a value level followed by specifying an order entry area. Subsequently, selection of the linked order entry initiates placement of the order based on the linked value. As another example, selection of a cell associated with a particular value level may link a pre-defined order entry area to the particular value level.

Upon selection of an order entry area to initiate placement of an order, one or more parameters of the order may be determined based on the selected order entry area. Order parameters may include order price, order quantity, order side, and/or order type. Other order parameters may be specified. Values for the parameters may be default values, preconfigured values, previously determined values, values set based on the location of the selection within the order entry area, values set based on the location of the order entry area, values set based on the method of the selection (e.g., a left click, a right click, a keyboard entry and a double click).

The manner in which the selection of an order entry area is made may affect the type of order or the way in which placement of an order is initiated. For example, selection within a row configured as an order entry area may include correlating the position of the selection to a specific cell or column arranged and aligned relative to the order entry area. The type of single action provided via the input device may further specify the selection. For example, if the user initiates a single action corresponding to a right click within an order entry area aligned with a portion of the row corresponding to a cell in the value column, then the selection may initiate placement of a buy order. Similarly, if the user initiates a single action corresponding to a left click over a portion of the row corresponding to a cell in the value column, then the selection may initiate placement of a sell order. As another example, selecting an order entry area encompassing the cells in the bid column may initiate placement of a buy market order when the selection is a single point touch applied to a touch sensitive interface and a buy sweep order when the selection is a two point touch to the touch sensitive interface.

FIGS. 4C to 4E illustrates examples of order entry area configurations that may be utilized to initiate placement of an order. FIG. 4C illustrates one configuration of a trading interface (identified as trading interface 400B) including order entry areas overlapping each cell making up a column. For example, selection of a particular order entry area 426 in bid column 402 may initiate placement of an order to buy a default quantity at the value level aligned with the selected order entry area. In operation, when the user selects an order entry area 426 overlapping the cell containing the bid quantity “80” in the illustrated example, the trading device 210 sends an order to sell a default quantity of 4 displayed in the quantity field 420 (see FIG. 4A) at a price of “96300”.

FIG. 4C further illustrates another configuration of the trading interface 400C including an order entry area overlapping an entire column. For example, selection within a portion of the order entry area 428 overlapping the ask column 406 initiates placement of an order to sell a default quantity at the value level corresponding to the selected portion of the order entry area. In operation, when the user selects within the order entry area 428 at a location corresponding to the cell displaying the ask quantity “69” in the illustrated example, the trading device 210 sends an order to buy a default quantity of 5 displayed in the quantity field 420 at a price of “96450”.

FIG. 4D illustrates another configuration of a trading interface (identified as trading interface 400D) including order entry areas overlapping cells defined within one or more of the columns in the same row. For example, an order entry area 430 may overlap a row 412 containing cells within each of the columns 402 to 406. In operation, selection within any portion of the order entry area 430 overlapping the row 412 initiates placement of an order to either buy or sell a default quantity at a price of “96300”. Determination of the side (e.g., buy or sell) of the order may be based on the method of the selection (e.g., a left click to initiate a buy order and a right click to initiate a sell order) and/or the position at which the selection was made (e.g., within a portion of the order entry area overlapping the buy column 402, within a portion of the value column 404 closer to the ask column 406. In another example, a first order entry area 432 overlaps a first cell in column 402 and part of a second cell in column 404, and a second order entry area 434 overlaps part of the second cell in column 404 and a third cell in column 406. In another example, individual order entry areas 436, 438 and 440 overlap aligned cells in each of the columns 402, 404 and 406.

FIG. 4D further illustrates order entry areas overlapping other elements of the trading interface 400D and aligned with the value levels of the value column. For example, an order entry area 442 encompasses multiple “Buy” elements 444 where each element 444 is aligned with a value level of the value column 404. In operation, selection within the order entry area 442 initiates placement of an order to buy a default quantity of the tradeable object. The order is at the price associated with the value level aligned with the element 444 at the location of the selection. In another example, order entry areas 446 overlay each individual “Sell” element 448, where each element 448 is aligned with a value level of the value column 404. In operation, selection of an order entry area 446 aligned with the cell in the value column 404 displaying the price “96425” results in a sell order for a default quantity being sent at the value level associated with the aligned cell.

FIG. 4E illustrates another configuration of a trading interface (identified as trading interface 400E) including order entry areas overlapping elements not aligned with the value levels of the value column. For example, an order entry area 450 encompasses multiple “Buy” elements 452a-452c configured to display different pre-set quantity levels and the currently selected price level. In operation, selection of a value level corresponding to the cell displaying the price “96300” links the selected value level with the order entry area 450. Another selection of a portion of order entry area 450 overlaying the element 452b results in a buy order for a quantity of 5 being sent at the linked price. Similarly, individualized order entry areas 454 overlaying “Sell” elements 456 may be selected to initiate placement of a sell order at a pre-defined quantity associated with the corresponding element 456 at the linked price.

### VI. Indicating a Market Trend Using a Graphical Indicator

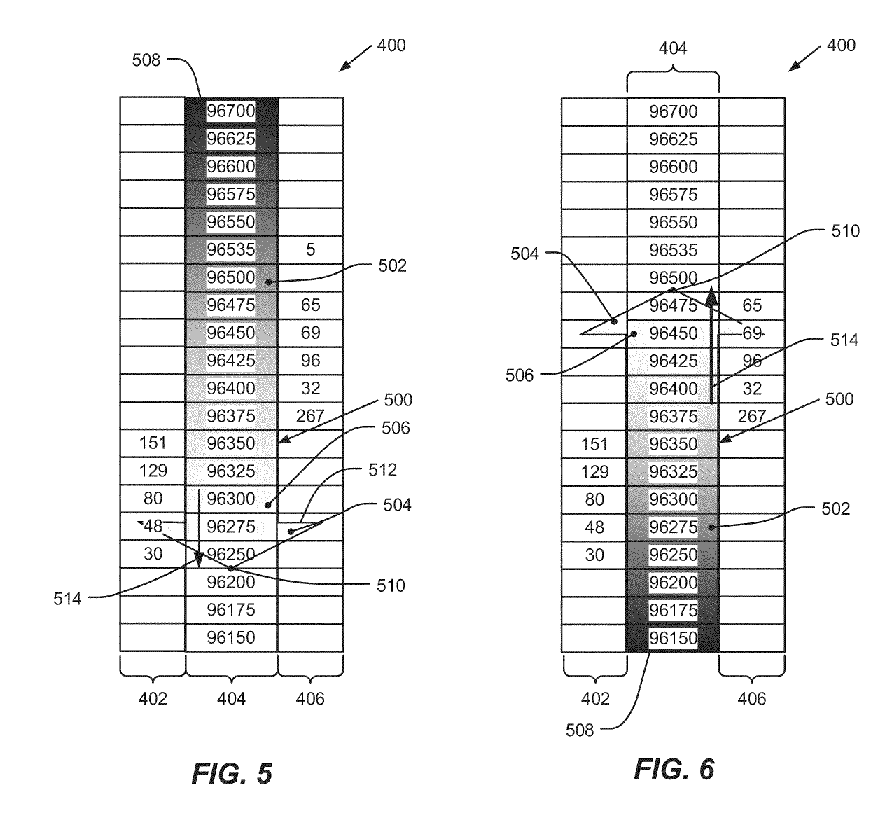

FIG. 5 illustrates an example graphical indicator 500 disclosed herein is displayed on the example trading interface 400 (shown in FIGS. 4A to 4E) to visually indicate a market trend. In the illustrated example, the graphical indicator 500 indicates the market trend between the volume of trades of the tradeable object and the price of the tradeable object. The market trend between the volume and the price is a pattern, correlation and/or relationship between the volume and the price. For example, the graphical indicator may indicate that the price is increasing, decreasing or substantially constant as the volume is increasing, decreasing or substantially constant. In some examples, the graphical indicator 500 is updated (e.g., periodically or substantially continuously) to indicate an up-to-date or current state of the market trend. In some examples, the graphical indicator 500 is updated (e.g., periodically or substantially continuously) to indicate the up-to-date or current state of the market trend.

The example graphical indicator 500 of FIG. 5 is an arrow having a tail 502 and a head 504. The head 504 includes a base 512 and a tip 510. The tail 502 includes a first end 506 adjacent to the base 512 of the head 504 and a second end 508 arranged distal to the first end 506 and the head 504. In the illustrated example, the graphical indicator 500 is displayed on and aligned with the value column 404. The example prices listed in the value column 404 overlay the graphical indicator 500. In other examples, the graphical indicator 500 is displayed in other locations within the trading interface 400 (e.g., in the bid column 402, in the ask column 406, in two or more of the columns 402, 404, 406, adjacent the bid column 402, and/or in any other location). In some examples, the interface 400 includes more than one graphical indicator to indicate the market trend and/or other market trends.

Thus, the example trading interface 400 provides a visual indication of the market trend (e.g., the graphical indicator 500) in addition to listing the market data (e.g., the price levels, the current traded volume, the bid quantities, the ask quantities and/or other information.) related to the tradeable object. In other examples, the graphical indicator 500 is displayed with respect to the trading interface 400 in other ways. For example, the graphical indicator 500 may be displayed alongside the example trading interface 400. In some examples, the graphical indicator 500 may be displayed in a first window or browser provided by the trading device 210 while the market data and/or the trading interface 400 is displayed in a second window or browser provided by the trading device 210.

In some examples, the graphical indicator 500 indicates the market trend over a period or window of time. In some examples, the window of time begins a predetermined amount of time before a current time and ends substantially at the current time. The current time is a time at or negligibly before a time at which the trading device 210 is being used by the user to communicate with the exchange 230, monitor market data, execute trades, and/or perform any other action via the trading device 210. For example, in a fast moving market, the window of time may begin eight seconds before the current time and end at substantially the current time. Thus, in this example, the graphical indicator 500 indicates the market trend between the volume of trades and the price over the last eight seconds. In other examples, the window of time includes other amounts of time (e.g., sixty seconds, twenty minutes, an hour, etc.).

In some examples, an amount of time in the window of time is adjustable via the interface 400. In some examples, the amount of time in the window of time adjusts substantially automatically. For example, the window of time may begin at a start time (e.g., when the market opens on a given day and/or at any other initial time) and end at the current time. Thus, in this example, the amount of time in the window of time increases as time passes to enable the graphical indicator 500 to indicate the market trend since the predetermined time.

In some examples, the graphical indicator 500 indicates the market trend over a price range. In some examples, the price range is in units of ticks (e.g., increments of the price). In some examples, the price range extends from the current price of the tradeable object to a price a predetermined number of ticks away from the current price. In some examples, the price range is based on recent prices of the tradeable object (e.g., detected prices of the tradeable object within a given amount of time of the current time, detected prices of the tradeable object within a predetermined number of ticks of the current price, etc.). Thus, in some examples, the graphical indicator 500 indicates the market trend over a recent and/or current price move of the tradeable object.

In some examples, the graphical indicator 500 is oriented to indicate a direction of change of the price of the tradeable object. In the illustrated example, the head 504 of the example graphical indicator 500 points in the direction of change or movement of the price of the tradeable object. If the trading device 210 determines that the price of the tradeable object is decreasing, the trading device 210 generates and/or updates the example graphical indicator 500 such that the head 504 points in the direction representing a decrease in the price of the tradeable object. In the illustrated example, the head 504 of the example graphical indicator 500 extends away from a first end 506 of the tail 502 and is configured such that the tip 510 points toward the lowest price listed in the example value column 404 to indicate that the price is decreasing. Moreover, in one example the cell 414 identified by the position of the tip 510 may correspond to the lowest price level currently trading, the lowest price within a predefined time period, or any other value related metric. In certain examples, the length of the tail 502 and the position of the tip 510 may vary to represent current market conditions. In operation, the length and position of the tip 510 may change in real or substantially real-time as the price at which the tradeable object trades varies to reflect market activity.

The example graphical indicator 500 of FIG. 5 further represents the volume of trades of the tradeable object over the window of time or the price range. In some examples, the graphical indicator 500 may be configured to represent a level of volume of the trades. The level of volume is the volume of trades of the tradeable object relative to a reference volume such as an average or median volume. In some examples, the median or average volume is determined based on volumes detected over a period of time, which may include, overlap or exclude the window of time. For example, the median volume may be determined based on volumes detected during a previous trading day or other historical references. In some examples, if the period of time includes or overlaps the window of time, the trading device 210 updates the median volume as example trading device 210 receives market data including the volume of trades during the window of time. In some examples, the level of volume is determined or calculated in units of percentile. For example, the median volume detected over the period of time may be a 50^{th} percentile, a highest volume detected in the period of time may be a 99^{th} percentile and a lowest volume detected in the period of time may be a 1^{st} percentile.

In some examples, the graphical indicator 500 employs colors to indicate the level of volume of the tradeable object. The example graphical indicator 500 of FIG. 5 includes a color gradient (e.g., a linear gradient) extending from a second end 508 of the tail 502 towards the first end 506 and the tip 510 of the head 504 to indicate the levels of volume of the tradeable object are changing within the window of time or over the identified price range. Each color corresponds to a given level of volume or range of levels of volume. For example, white portions of the graphical indicator 500 may correspond to volumes between the 1^{st} and 5^{th} percentiles (e.g., low volume levels), black portions of the graphical indicator 500 may correspond to volumes between the 95^{th} and 99^{th} percentile (e.g., high volume levels), etc. In the illustrated example, the second end 508 of the tail 502 corresponds to the beginning of the window of time, and the tip 510 corresponds to the current time. Thus, in the illustrated example, the graphical indicator 500 visually indicates a relationship between the volume and a change of the price: the tradeable object is decreasing in price and volume over the window of time. In some examples, other portions of the graphical indicator 500 correspond to the current price and/or a price a predetermined number of ticks away from the current price.

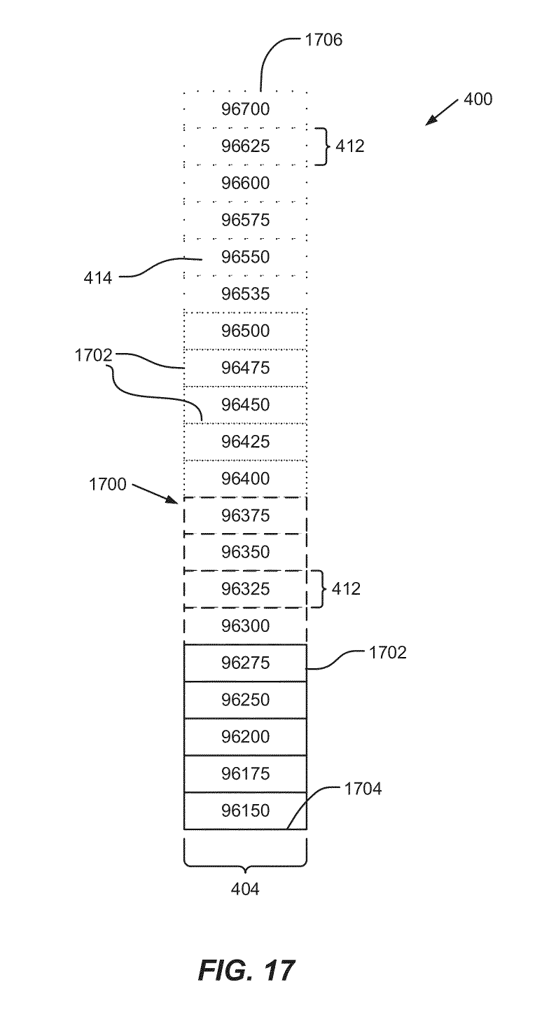

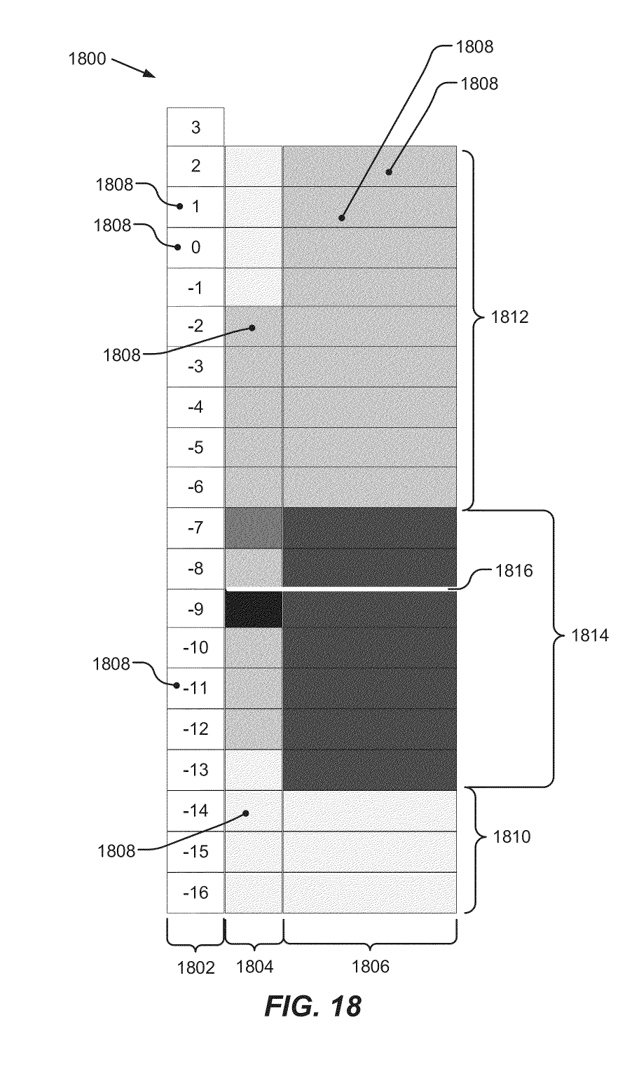

While the example graphical indicator 500 of FIG. 5 is an arrow, other example graphical indicators have other shapes, forms, appearances, features, sizes and/or characteristics. In one example, the graphical indicator 500 may be arrows of other shapes, sizes, styles, types, colors, etc. For instance, the size or shape of the head 504 of an arrow shaped graphical indicator 500 may be adjusted to indicate the rate at which a change is occurring. For example, a large arrow head 504 could represent a large change in volume between successive updates or a rapid change in prices, etc. The rate or frequency at which the size or shape of the head 504 varies may directly reflect conditions within the market. In some configurations, the rate or frequency at which the size or shape of the head 504 varies may be determined by, for example, the duration between the last price change, the volume traded, the amount of time at a value level between price changes, and any other user specified thresholds. In another example, the graphical indicator 500 may include or cooperate with a secondary indicator 514 which may be configured to indicate the streak or number of changes in the same direction. In operation, the length of the secondary indicator 514 may increase when the movement or trend in the market continues in the same direction (e.g., the trend indicates a continued decrease or downward market movement.) Similarly, the secondary indicator 514 shown in FIG. 6 illustrates a sustained and continuing increase or upward market movement. In some examples, the graphical indicator 500 is not an arrow (FIGS. 17-18). For example, the graphical indicator may be a symbol, an icon, an object and/or other type of graphical indicator. In some examples, the graphical indicator 500 is generated via components of the interface by, for example, displaying lines of the interface 400 in different and/or varying line thicknesses, colors and/or patterns; displaying one or more patterns and/or colors on one or more areas or portions (e.g., the cells 414) of the interface 400; displaying numerals and/or text (e.g., the bid quantities, the prices, the ask quantities, and/or any other numerals and/or text) in different and/or varying colors, line thicknesses, line patterns, fonts, sizes, etc. In some examples, the graphical indicator 500 is generated by flashing, blinking and/or moving one or more portions (e.g., one or more the cells 414) of the example interface 400.

FIG. 6 illustrates the example graphical indicator 500 of FIG. 5 updated to indicate a market trend in which the price is increasing while the volume at the increased levels is decreasing. For example, the head 504 of the example graphical indicator 500 of FIG. 6 points toward a highest price listed in the example value column 404 (e.g., upward in the orientation of FIG. 6). Thus, the example graphical indicator 500 indicates that the price is increasing. In addition, the example graphical indicator 500 transitions from black at the second end 508 to white at the tip 510 to indicate that the volume level of the trades of the tradeable object is decreasing. Thus, the user may visually detect that this example market trend provides a profitable opportunity to go short and use the example interface 400 to execute one or more trades. In another embodiment, the example graphical indicator 500 could be split into left and right portions and used to display more than one factor. For example, a left portion could display market trends as a function of quantity while the right half could display market trends as a function of time.

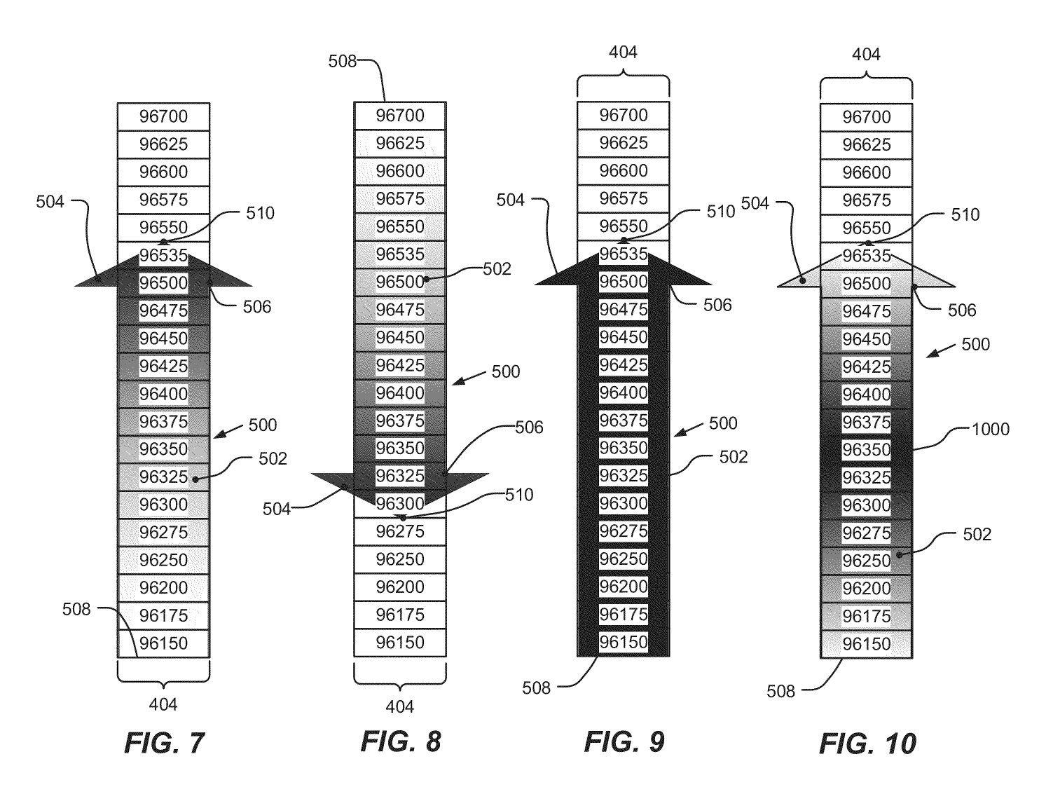

FIGS. 7-10 illustrate several views of the example graphical indicator 500 updated to indicate other example market trends. In the examples illustrated in FIGS. 7-10, only the value column 404 of the example trading interface 400 is shown. In FIG. 7, the example graphical indicator 500 indicates a market trend in which the price and the volume are increasing. In FIG. 8, the example graphical indicator 500 indicates a market trend in which the volume is increasing as the price is decreasing. The example graphical indicator 500 of FIG. 9 indicates a market trend in which the volume level remains substantially constant (e.g., within the 95^{th} to 99^{th} percentile) while the price is increasing. In FIG. 10, the example graphical indicator 500 indicates that the level of volume of trades of the tradeable object is fluctuating as the price is increasing. For example, the second end 508 of the graphical indicator 500 is substantially white (e.g., white, light grey, etc.), a middle section 1000 (see FIG. 10) of the graphical indicator 500 is substantially black, and the tip 510 of the head 504 is substantially white to indicate that the level of volume has risen and fallen over the window of time. Other examples indicate other market trends. Thus, the user may quickly and easily recognize the market trend based on the color(s) and the orientation (e.g., pointing direction) of the example graphical indicator 500.

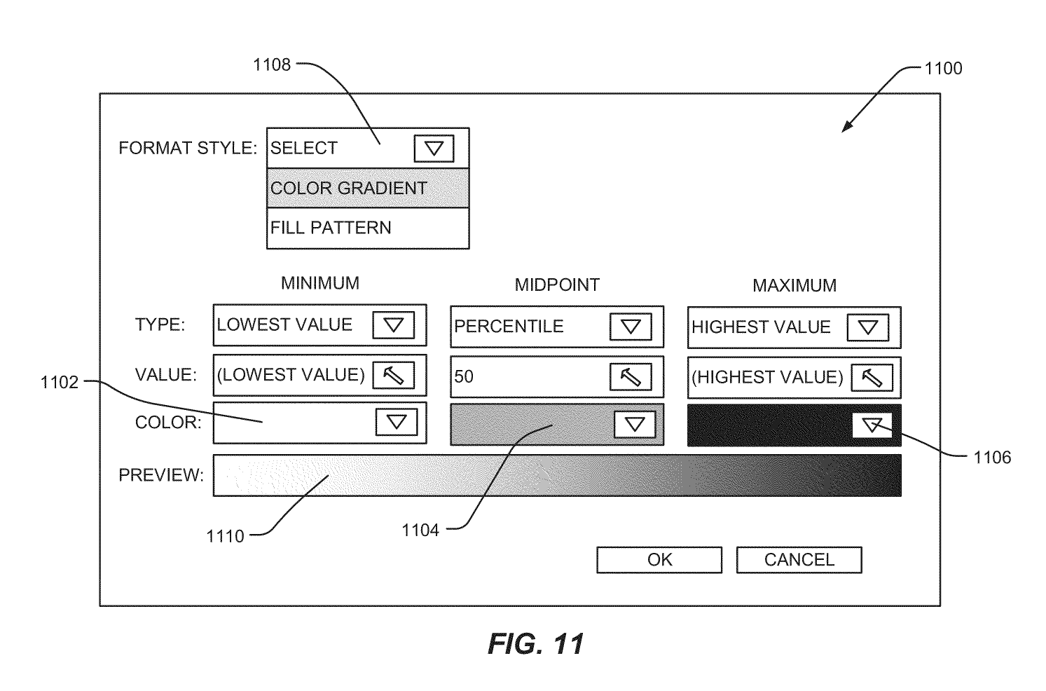

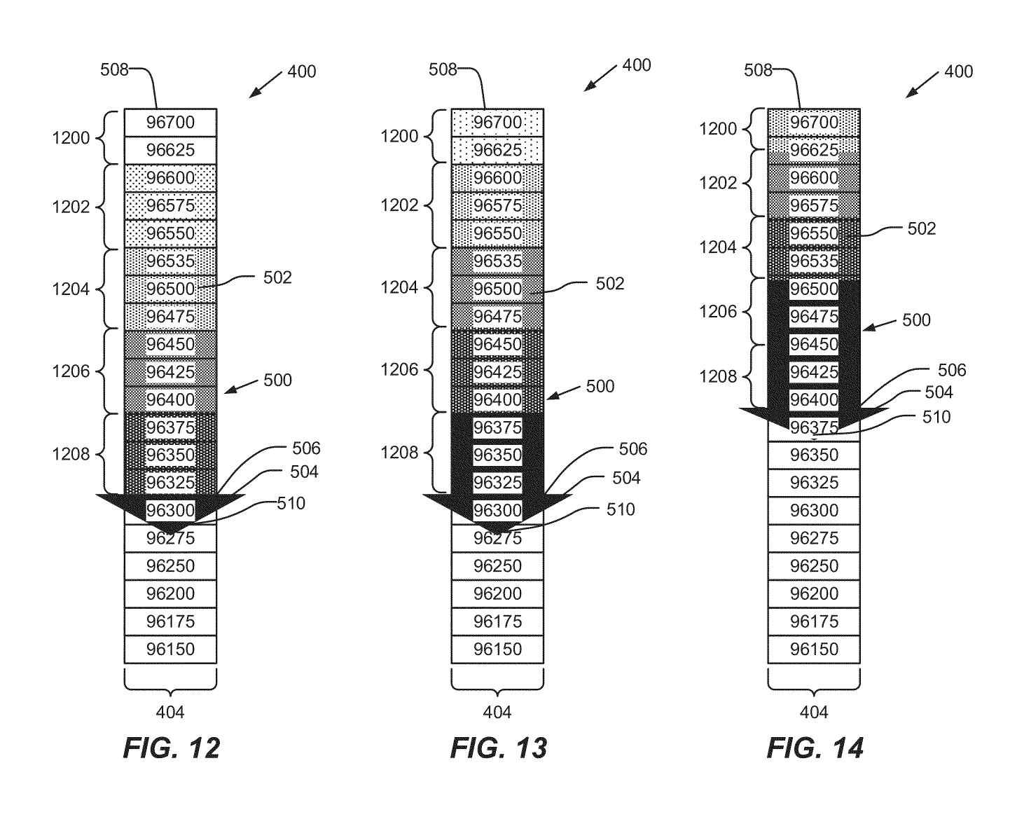

FIG. 11 illustrates an example menu 1100 provided by the example trading device 210 to enable the user to adjust or customize settings, features, and/or characteristics of the example graphical indicator 500 of FIGS. 5-10. In the illustrated example, the user may adjust the colors (e.g., via a three color scale) corresponding to a first (e.g., lowest) level of volume, a second level of volume (e.g., the 50^{th} percentile) and a third (e.g., highest) level of volume via a first dropdown list 1102, a second dropdown list 1104 and a third dropdown list 1106, respectively. For example, the user may select a first color corresponding to the first level of volume to be red; a second color corresponding to the second level of volume to be yellow; and a third color corresponding to the third level of volume to be green. In this example, if the levels of volume over the window of time change from the second level of volume to the third level of volume, the graphical indicator 500 displayed via the example interface 400 includes a color gradient from yellow to green. If the levels of volume over the window of time change from the third level to the first level, the example graphical indicator 500 includes a color gradient from green at the second end 508 to red at the tip 510. The example menu 1100 also enables the user to adjust a format of the example graphical indicator 500 via a fourth dropdown list 1108. In the illustrated example, the user may select between “Color Gradient” and “Fill Pattern.” If the user selects “Color Gradient,” the example graphical indicator 500 includes one or more colors to indicate a market trend (FIGS. 5-10). If the user selects “Fill Pattern,” the example graphical indicator 500 includes one or more fill patterns (FIGS. 12-14) to indicate the market trend. For example, one fill pattern may utilize one or more arrowheads such as the head 504 to indicate changes in trading volume or intensity. In one example, the number, size and formatting of the arrowheads may be associated with different levels of volume, rates of change, etc. The example menu 1100 also includes a field 1110 that displays a preview of the graphical indicator 500 based on the settings, features and/or characteristics selected via the menu 1100.

FIGS. 12-14 illustrate the example graphical indicator 500 having patterns to indicate levels of volume of the tradeable object. In the illustrated examples, the patterns include substantially white areas overlaid by dots. In some examples, a density or number of dots on the graphical indicator 500 corresponds to the levels of volume. For example, a substantially white area (e.g., an area having at or near zero dots) corresponds to a low volume level (e.g., between a 1^{st} and 5^{th} percentile) and a substantially black area corresponds to a high volume level (e.g., between a 95^{th} and 99^{th} percentile), etc. Referring to FIG. 12, the dots increase in density from the second end 508 of the tail 502 to the head 504 of the example graphical indicator 500. Thus, the example graphical indicator 500 of FIG. 12 indicates that the level of volume is increasing (e.g., from the low level of volume to the high level of volume) over a first window of time. Other examples employ other fill patterns (e.g., cross-hatching, etc.).

In the illustrated example, a length of the graphical indicator 500 (e.g., measured from the second end 508 of the tail 502 to the tip 510 of the head 504) indicates a rate of change of the price over the first window of time. The length of the example graphical indicator 500 of FIG. 12 corresponds to a first rate of change of the price. In other examples, other dimensions (e.g., a width), features and/or characteristics of the graphical indicator 500 indicate the rate of change of the price. The example head 504 of the graphical indicator 500 shown in FIG. 12 points towards the lowest price listed in the example value column 404. Thus, the example graphical indicator 500 indicates a market trend in which the level of volume is increasing while the price is decreasing.

In the illustrated example, the tail 502 of the graphical indicator 500 includes a first section 1200, a second section 1202, a third section 1204, a fourth section 1206 and a fifth section 1208. Each of the example sections 1200, 1202, 1204, 1206, 1208 and the head 504 of the example graphical indicator 500 indicates the volume level over a portion of the first window of time. In the illustrated example, the sections 1200, 1202, 1204, 1206, 1208 and the head 504 of the example graphical indicator 500 indicate the volume level in chronological order. For example, if the first window of time begins twelve seconds before the current time, the first section 1200 indicates the level of volume over an initial or first two seconds of the first window of time; the second section 1202 indicates the level of volume over a second two seconds of the first window of time after the first two seconds; the third section 1204 indicates the level of volume over a third two seconds after the second two seconds; the fourth section 1206 indicates the level of volume over a fourth two seconds after the third two sections; the fifth section 1208 indicates the level of volume over a fifth two seconds after the fourth two seconds; and the head 504 of the example graphical indicator 500 indicates the level of volume over a sixth two seconds after the fifth two seconds. In other examples, the sections 1200, 1202, 1204, 1206, 1208 and/or the head 504 of the example graphical indicator 500 indicate the levels of volume over other amounts of time. Other examples have other numbers of sections (e.g., 1, 2, 3, 4, 6, 7, etc.).

FIG. 13 illustrates the example graphical indicator 500 of FIG. 12 updated to indicate the market trend over a second window of time. In the illustrated example, the second window of time overlaps a portion (e.g., ten seconds) the first window of time. For example, the trading device 210 monitors the volume of trades over a seventh two seconds after the sixth two seconds and calculates the level of volume of trading over the seventh two seconds. In the illustrated example, the trading device 210 determines that the level of volume over the seventh two seconds is the high volume level. As a result, the example trading device 210 updates the graphical indicator 500 by updating the fill pattern of the head 504 to correspond to the high volume level over the seventh two seconds (e.g., the head 504 is updated to be substantially black). In addition, the fifth section 1208 of the tail 502 is updated to indicate the level of volume over the sixth two seconds; the fourth section 1106 is updated to indicate the level of volume over the fifth two seconds; the third section 1204 is updated to indicate the level of volume over the fourth two seconds; the second section 1202 is updated to indicate the level of volume over the third two seconds; and the first section 1200 is updated to indicate the level of volume over the second two seconds. As illustrated the example, the patterns of the graphical indicator 500 change or shift to indicate changes in the trend on an up-to-date or rolling basis.

The length of the example graphical indicator 500 of FIG. 13 is equal to the length of the same graphical indicator 500 shown in FIG. 12. Thus, the graphical indicator 500 indicates that rate of change of the price over the second window of time is substantially the same as the rate of change over the first window of time.

FIG. 14 illustrates the example graphical indicator 500 of FIG. 13 updated to indicate the market trend over a third window of time. The example third window of time overlaps a portion of the second window of time and includes an eighth two seconds after the seventh two seconds. The example head 504, the fifth section 1208 of the tail 502 and the fourth section 1206 of the tail 502 are updated to be substantially black in the illustrated example. Thus, the example graphical indicator 500 of FIG. 14 indicates that the level of volume has substantially remained at the high volume level during the eighth two seconds.

The example graphical indicator 500 of FIG. 14 is also updated to indicate a change in the rate of change of the price of the tradeable object. In the illustrated example, the graphical indicator 500 has a second length less than the first length. The second length corresponds to a second rate of change of the price less than the first rate of change. In some examples, the rate of change of the price is calculated for a portion of the third window of time. For example, the example graphical indicator 500 of FIG. 14 indicates that the rate of change of the price has decreased over the eighth two seconds relative to the rate of change of the price over the seventh two seconds. In other examples, the rate of change of the price is calculated for the other portions of the third window of time, the entire third window of time, and/or other periods of time. The example graphical indicator 500 of FIGS. 12-14 indicates the market trend of the tradeable object.

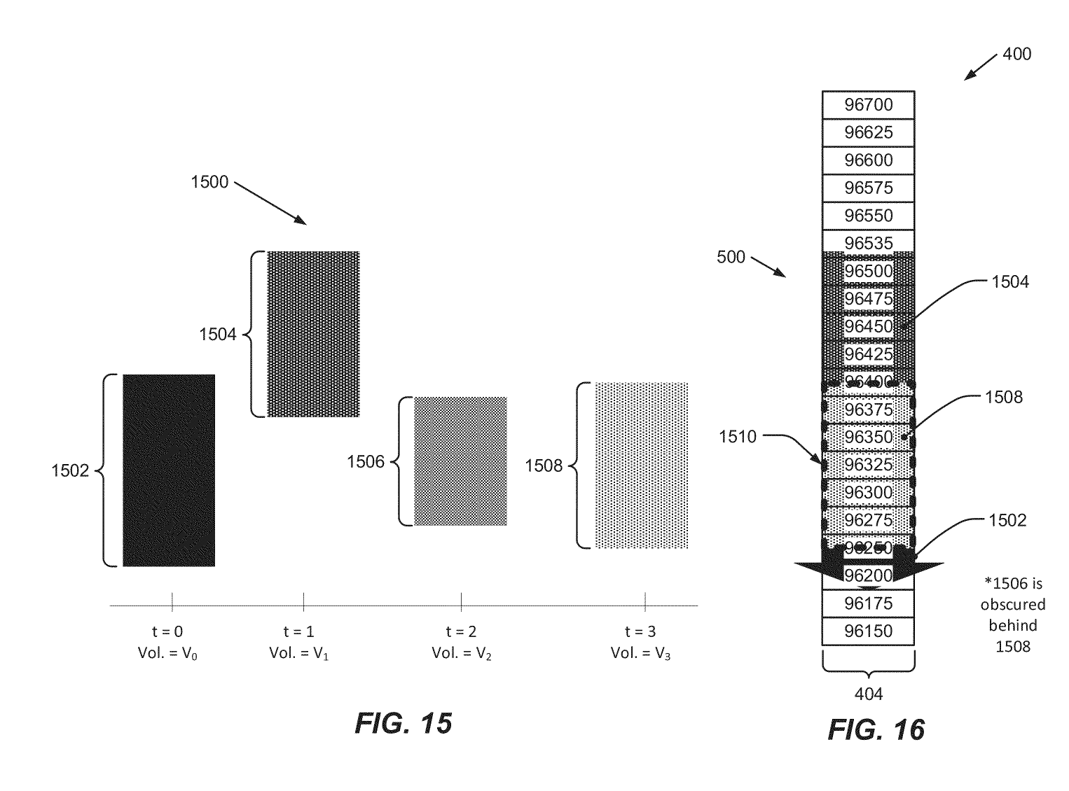

FIGS. 15 and 16 illustrate another example of the graphical indicator 500 including multiple display sections of elements that may be layered or otherwise arranged to display movement in the market. FIG. 15 illustrates a plurality of market snapshots 1500 individually identified as a first section 1502, a second section 1504, a third section 1506 and a fourth section 1508. The individual sections 1502 to 1508 comprising the plurality of market snapshots 1500 may be combined to construct the example graphical indicator 500. For example, the individual sections 1502 to 1508 comprising the plurality of market snapshots 1500 may be arranged as a function of time “t”. In particular, each of the sections 1502 to 1508 corresponds to a different period or snapshot of market activity. For example, at time t=1, the second section 1504 indicates that a low price of 96375 and a high price of 96535. Similarly, the shading or color assigned to fill the second section 1504 may indicate the volume V₁ of trades recorded at during the time period represented by the time t=1. The shading or color assigned to the second section 1504 may represent: an aggregate traded volume V₁, the trade volume at the end of the time period represented by the time t=1, the highest volume traded during the identified time period, or any other configurable parameter discussed herein. The sections 1502, 1506 and 1508 may be similarly configured to represent the trading activity over the corresponding time periods. New sections may be triggered based on elapsed time, traded volume, detection of a triggering event or any other market related trigger.

FIG. 16 illustrates an example graphical indicator 500 constructed by organizing and layering the individual sections 1502 to 1508 comprising the plurality of market snapshots 1500 as a function of time. For example, each of the sections 1502 to 1508 may be organized from oldest to newest (e.g., from time t=0 to time t=3) and displayed on the value column 404. Thus, the first section 1502 corresponding to time t=0 may be displayed “behind” the second section 1504 corresponding to time t=1. Each subsequent section (i.e., sections 1506 and 1508 in the present example) may be generated and displayed “on top” of the previously displayed section. In this way, the sections can be layered such that the newest and most up-to-date section appears closest to the user. In constructing the layered graphical indicator 500, more recent sections are arranged and configured to overlay and obscure older sections as current market data is received. For example, the fourth section 1508 completely obscures the third section 1506 while leaving portions of the first section 1502 and the second section 1504 visible. In this configuration, a user can determine that the market has previously reached a high of 96535 as illustrated by the visible portion of the second section 1504 and a low of 96200 as illustrated by the visible portion of the first section 1502. Moreover, the visible portions of the sections 1502 and 1504 indicate the volumes traded during the corresponding times t=1 and t=2 as a function of the individual fill patterns visible to the user. The fourth section 1508 may be further identified as the current or active section by a border 1510. As additional sections are added, the border 1510 may shift to automatically highlight the most up-to-date section. Similarly, as previous sections age (i.e., as the information presented becomes increasingly stale) they may be assigned a historical fill pattern. As more and more sections are assigned to a common historical fill pattern, the user will be able to quickly identify the market highs and lows based on the aggregated displayed created by combining the older sections using a common fill pattern.

FIG. 17 illustrates another example graphical indicator 1700 disclosed herein. In the illustrated example, components or elements of the example trading interface 400 form the graphical indicator 1700. More specifically, borders 1702 of the rows 412 and cells 414 of the value column 404 form the graphical indicator 1700. In some examples, a bottom 1704 of the value column 404 corresponds to a beginning of the window of time, and a top 1706 of the value column 404 corresponds to an end of the window of time (e.g., the current time). In other examples, other portions of the trading interface 400 correspond to the beginning and/or the end of the window of time. In the illustrated example, line patterns of the borders 1702 indicate the level(s) of volume of the tradeable object. In some examples, broken or dashed lines may indicate a lower level of volume than solid lines. Other examples employ additional and/or different line patterns and/or styles. In yet other examples, the value or price information within the value column 404 could fade or change font and/or color along with the borders 1702. In the illustrated example, the borders 1702 are shown as solid lines at the bottom 1704 of the value column 402 and broken lines at the top 1706 of the value column 404. Thus, the example graphical indicator 1700 of FIG. 17 indicates that the level of volume is decreasing over the window of time.

FIG. 18 illustrates another example graphical indicator 1800 disclosed herein to indicate a market trend between a volume of trades and a price of a tradeable object. In the illustrated example, the graphical indicator 1800 indicates a relationship between volume levels and prices over three windows of time. Although the example graphical indicator 1800 of FIG. 18 is discussed in conjunction with the example trading device 210 of FIG. 2, the example graphical indicator 1800 may be implemented via any trading device. In some examples, the graphical indicator 1800 is provided on a trading interface such as the example trading interface 400 of FIG. 4.

In the illustrated example, the graphical indicator 1800 includes a bid column 1802, a value column 1804 and a ask column 1806. Each of the example columns 1802, 1804, 1806 includes a plurality of cells 1808. Other examples include other numbers of columns, rows, cells and/or employ other organizational structures.

In the illustrated example, the bid column 1802 includes a plurality of value levels configured to represent prices, price derivatives and other representations of value. Each of the example prices contained in the displayed value levels are separated by one tick (i.e., the smallest incremental change in value that may be experienced by the tradeable object). Other examples list values of the prices, price derivatives and/or other information in the bid column 1802. In the illustrated example, the ticks are listed in descending order from a top to a bottom of the bid column 1802 in the orientation of FIG. 18. In other examples, the ticks and/or other information are listed in other orders (e.g., ascending order from the top to the bottom).

The example value column 1804 includes one of the cells 1808 for each tick at which the tradeable object has traded during the windows of time. Thus, in the illustrated example, the graphical indicator 1800 indicates that the tradeable object has traded between two ticks and −16 ticks because the example value column 1804 includes the cells 1808 adjacent the cells 1808 labeled “−16” through “2” in the bid column 1802. The example graphical indicator 1800 also indicates that the tradeable object has not traded at three ticks by not including cells in the second and ask columns 1804, 1806 adjacent the cell 1808 labeled “3” in the bid column 1802. Other examples indicate the prices at which the tradeable object has traded in other ways.

The cells 1808 of the example value column 1804 include shading indicative of the level of volume of the tradeable object at each of the ticks. In some examples, the level of volume indicated at each of the ticks is determined based on a percentile of the volume detected at each of the ticks. In some examples, the percentile at each tick is associated with one of a plurality of ranges of percentiles, where each range corresponds to a given shading. For example, when the trading device 210 detects the volume at a given tick, the trading device 210 determines the percentile of the volume and associates the volume with one of the plurality of ranges of percentiles. Based on the range, the trading device 210 generates and/or updates the value column 1804 to include one of the cells 1808 having shading corresponding to the determined range. In one configuration, a volume having a percentile within a range of 0 to 20 percent may be indicated by coloring one of the cells 1808 white, a volume having a percentile within a range of 20 to 40 percent may be indicated by coloring one of the cells 1808 grey, a volume having a percentile within a range of 80 to 100 percent may be indicated by a coloring one of the cells 1808 black, etc. Thus, in the illustrated example, the graphical indicator 1800 indicates that the level of volume of trades within the range of 80 to 100 percent occurred at −9 ticks. Other examples determine and/or indicate the levels of volume in other ways.

The example ask column 1806 of FIG. 18 includes shading indicative of a first window of time, a second window of time and a third window of time. In the illustrated example, the first window, the second window and the third window occur consecutively. A first section 1810 of the example ask column 1806 has first shading to indicate the first window of time. A second section 1812 of the example ask column 1806 has second shading indicative of the second window of time, and a third section 1814 of the example ask column 1806 has third shading indicative of the third window of time. Alternatively, the information displayed in the ask column 1810 could be incorporated into and/or overlaid onto the bid column 1810 thereby eliminating the need for the additional column and freeing up screen real estate. Other examples include other numbers of sections to indicate other numbers of windows of time. In some examples, an amount of time in each of the windows of time is different. In some examples, additionally or alternatively, colors, patterns, markings and/or other types of shadings are used to indicate the windows of time.

In some examples, the example trading device 210 is updated to add one or more of the cells 1808 in the value column 1804 and/or the ask column 1806 based on market data detected by the trading device 210. For example, the value column 1804 and the ask column 1806 of FIG. 18 do not include one of the cells 1808 adjacent the cell 1808 labeled “3” in the bid column 1802 to indicate that no trades of the tradeable object have occurred at three ticks. If the trading device 210 subsequently determines that the tradeable object traded at three ticks, the trading device 210 updates the graphical indicator to include one of the cells 1808 in the value column 1804 and one of the cells 1808 in the ask column 1806 adjacent the cell 1808 labeled “3” in the bid column 1802. In some examples, shading in the value column 1804 and the ask column 1806 are also updated to indicate the level of volume of trades at three ticks and the window of time during which the tradeable object was traded at three ticks, respectively.

The example ask column 1806 also includes a line 1816 to indicate a price at which the tradeable object has last been traded (e.g., the last traded price). In the illustrated example, the graphical indicator 1800 is updated to include the line 1816 adjacent the tick at which the tradeable object last traded. Other examples indicate the last traded price in other ways such as by updating the graphical indicator 1800 to change a color of the tick at which the object has last been traded, flashing one or more of the cells 1808, etc. When the example trading device 210 receives market data including a different last traded price, the graphical indicator 1800 is updated to include the line 1816 in a different location corresponding to the last traded price. In another example, the position of the line 1816 within the cell 1808 can be adjusted to reflect, for example, the ratio of the ask quantity to the bid quantity, or the ratio of the bid or ask quantities to the total quantity traded at that level.

Thus, in the illustrated example, the graphical indicator 1800 indicates that within the third window of time, the tradeable object has traded at prices between −7 and −13 and at the last traded price of −8. The example graphical indicator 1800 also indicates that various levels of volume of trades occurred at various prices, including the high volume level of trades at −9 ticks. The example graphical indicator 1800 further indicates that the tradeable object traded between 2 ticks and −6 ticks during the second window of time, and the tradeable object traded between −14 ticks and −16 tickets during the first window of time. The example graphical indicator 1800 also indicates that no trades occurred at 3 ticks.

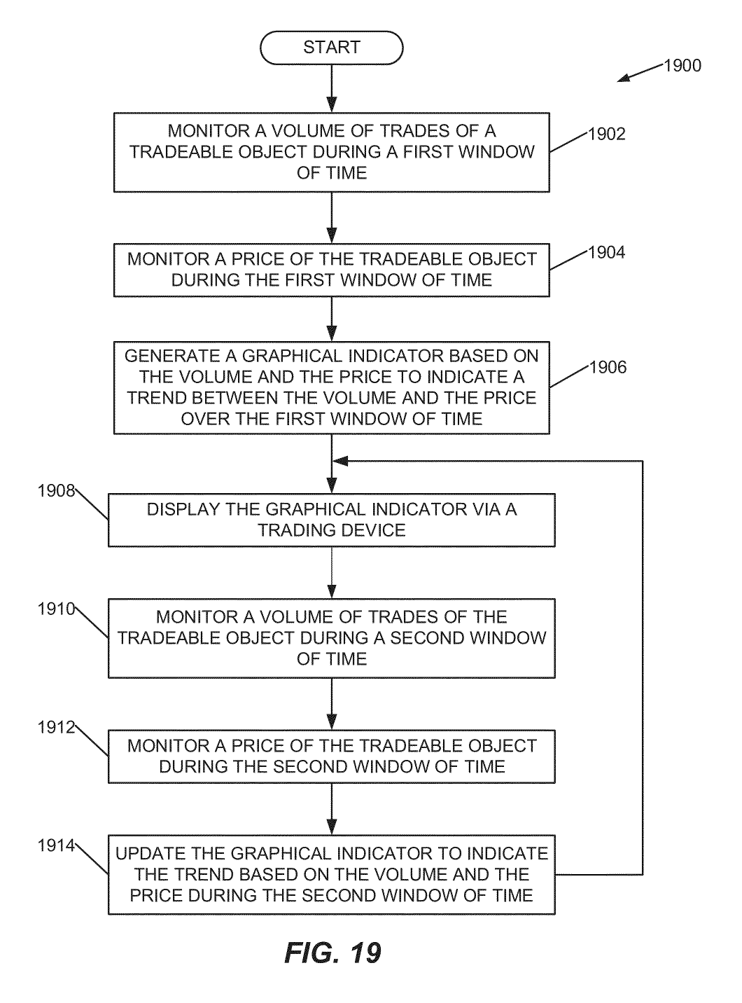

FIG. 19 is a flow diagram representative of an example method 1900 to indicate a market trend via a graphical indicator. In the illustrated example, a volume of trades of a tradeable object is monitored during a first window of time (block 1902). In some examples, the first window of time is a period of time ending substantially with a current or present time at which a trading device is being operated to communicate with an electronic exchange, monitor market data, execute trades of the tradeable object, and/or perform other actions.

In some examples, a first level of volume of trades is determined based on the volume of trades. For example, the first level of volume may be a percentile of the volume relative to previously detected volumes. In some examples, the level of volume is a difference between the volume of trades and a median volume of trades over a period of time, which may include or overlap the first window of time.

A price of the tradeable object is also monitored during the first window of time (block 1904). In some examples, whether the price is changing during the first window of time is determined. For example, it is determined if the price is increasing, decreasing or substantially constant during some or all of the first window of time. In some examples, an amount of the change of the price (e.g., two ticks) during some or all the first window of time and/or a rate of change of the price is determined.

Based on the volume and the price, a graphical indicator is generated to indicate a trend between the volume and the price over the first window of time (block 1906). In some examples, the trend between the volume and the price is a first level of volume associated with a direction of change of the price. In some examples, one or more markings, patterns, colors and/or other features of the graphical indicator indicate the first level of volume. For example, a first portion of the graphical indicator may be a first color to indicate the first level of volume. If the volume changed to the first level of volume during the first window of time, the graphical indicator may include a color gradient (e.g., red to orange to green) to indicate an amount and/or a direction of change (e.g., an increase or a decrease) of the volume during the first window of time.

In some examples, an orientation of the graphical indicator indicates the direction of change of the price. In some examples, the graphical indicator is an arrow pointing in a direction associated with the direction of change of the price. For example, if the price is increasing over the first window of time, a head of the graphical indicator may point upwards, toward a maximum price listed on the trading interface, and/or any in other direction associated with the direction of the change of the price. In some examples, a size of the graphical indicator is based on the amount of the change of the price during the first window of time. For example, a length of the graphical indicator may be based on the amount of the change of the price.

The graphical indicator is displayed via a trading device (block 1908). In some examples, the trading device displays the graphical indicator within a trading interface including market data related to the tradeable object (e.g., prices or price levels, volumes, ask quantities, bid quantities and/or other information). In some examples, the trading interface is to be used to execute trades via an electronic exchange. In some examples, the trading interface and/or the graphical indicator include prices or price levels (e.g., ticks) of the tradeable object. In some examples, the prices or price levels overlay the graphical indicator.

In the illustrated example, a volume of trades of the tradeable object is monitored during a second window of time (block 1910). The second window of time may overlap a portion of the first window of time. In some examples, the median volume is updated based on the volume of trades detected during the second window or time, and a second level of volume of the trades is determined based on the volume of trades detected during the second window of time and the median volume.

A price of the tradeable object is also monitored during the second window of time (block 1912). In some examples, whether the price is changing during the second window of time is detected. In some examples, an amount of the change and/or the rate of change of the price are determined.

The graphical indicator is then updated to indicate the market trend based on the volume and the price during the second window of time (block 1914). For example, the color of one or more portions or sections of the graphical indicator may be updated (e.g., changed) based on the second level of volume of trades to indicate, for example, a change between the second level of volume and the first level of volume. In some examples, if the rate of change of the price changes from the first window of time to the second window of time, a size of the graphical indicator is updated. For example, if the rate of change of the price slows or decreases, the graphical indicator may be updated to decrease the size of the graphical indicator. In some examples, if the direction of change of the price during the second window of time is different than the direction of change of the price during the first window of time, an orientation of the graphical indicator is updated. For example, if the price is increasing during the first window of time and decreasing during the second window of time, the graphical indicator may be updated from pointing toward the largest price listed in the trading interface to pointing toward a smallest price listed in the trading interface. In some examples, the graphical indicator is updated to add a feature to the graphical indicator. The example method 1900 then returns to block 1908, and the example graphical indicator is displayed via the trading device. The graphical indicator indicates the trend (e.g., a relationship between the volume and the price) on a rolling and/or up-to-date basis.

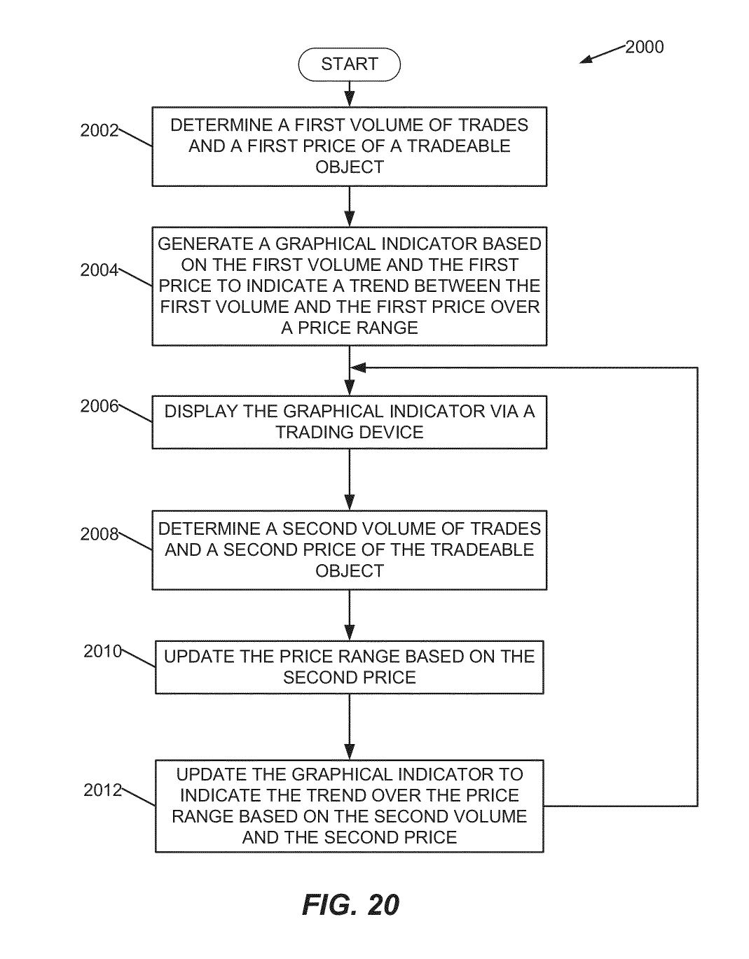

FIG. 20 is a flow diagram representative of another example method disclosed herein to indicate a market trend via a graphical indicator. The example method 2000 begins by determining a first volume of trades and a first price of a tradeable object (block 2002). In some examples, a trading device (e.g., the trading device 210 of FIG. 2) receives market data including the first volume of trades and the first price of the tradeable object from an electronic exchange. In some examples, a first level of volume of trades is determined based on the first volume of trades. For example, the first level of volume may be a percentile of the volume relative to previously detected volumes. In some examples, the first level of volume is a difference between the first volume of trades and a median volume of trades over a period of time. In some examples, whether the price is changing is determined. For example, it is determined if the price is increasing, decreasing or substantially constant. In some examples, an amount of the change of the price and/or a rate of change of the price is determined.

Based on the first volume and the first price, a graphical indicator is generated to indicate a trend between the first volume and the first price over a price range (block 2004). In some examples, the price range is in units of ticks (e.g., increments of the price). In some examples, the price range extends from the current price to a price that is a predetermined number of ticks away from the current price.

In some examples, one or more markings, patterns, colors and/or other features of the graphical indicator indicate the first volume or the first level of volume. For example, a first portion of the graphical indicator may be a first color associated with the first level of volume. If the volume is increasing over the price range, the graphical indicator may include a color gradient (e.g., red to orange to green) to indicate that the volume changed to, for example, the first level of volume over the price range.

In some examples, an orientation of the graphical indicator indicates the direction of change of the price. In some examples, the graphical indicator is an arrow pointing in a direction associated with the direction of change of the price. For example, if the price is increasing over the price range, the head may point upwards, toward a maximum price listed on the trading interface, and/or any in other direction associated with the direction of the change of the price. In some examples, a size of the graphical indicator is based on a rate of change of the price over the price range. For example, a length of the graphical indicator may be based on the rate of change of the price.

The graphical indicator is displayed via a trading device (block 2006). In some examples, the trading device displays the graphical indicator within a trading interface including market data related to the tradeable object (e.g., prices or price levels, volumes, ask quantities, bid quantities and/or other information). In some examples, the trading interface is to be used to execute trades via an electronic exchange. In some examples, the graphical indicator and/or the trading interface includes a list of the prices or price levels in the price range. In some examples, the prices or price levels overlay the graphical indicator.

A second volume of trades and a second price of the tradeable object is determined (block 2008). In some example, a second level of volume is determined based on the second volume. In some examples, the median volume is updated based on the second volume, and the second level of volume is determined based on the median volume. In some examples, whether the price is changing is determined based on a difference between the second price and the first price. In some examples, an amount of the change of the price and/or a rate of change of the price is determined.

In the illustrated example, the price range is updated based on the second price (block 2010). For example, if the second price is outside of the price range, the second price range is updated include to the second price and prices within the given number of ticks from the second price. The graphical indicator is then updated to indicate the trend over the price range based on the second volume and the second price (block 2012). For example, one or more colors of the graphical indicator may be changed based on the second level of volume of trades to indicate a change between the second level of volume and the first level of volume. In some examples, if the rate of change of the price changes, a size of the graphical indicator is updated. For example, if the rate of change of the price slows or decreases, the graphical indicator may be updated to decrease the size of the graphical indicator. In some examples, if the direction of change of the price changes, an orientation of the graphical indicator is updated. In some examples, the graphical indicator is updated to add a feature to the graphical indicator.

The example method 2000 then returns to block 2006, and the graphical indicator is displayed via the trading device. As illustrated in the example, the graphical indicator indicates the trend between the volume and the price on a rolling and/or up-to-date basis.

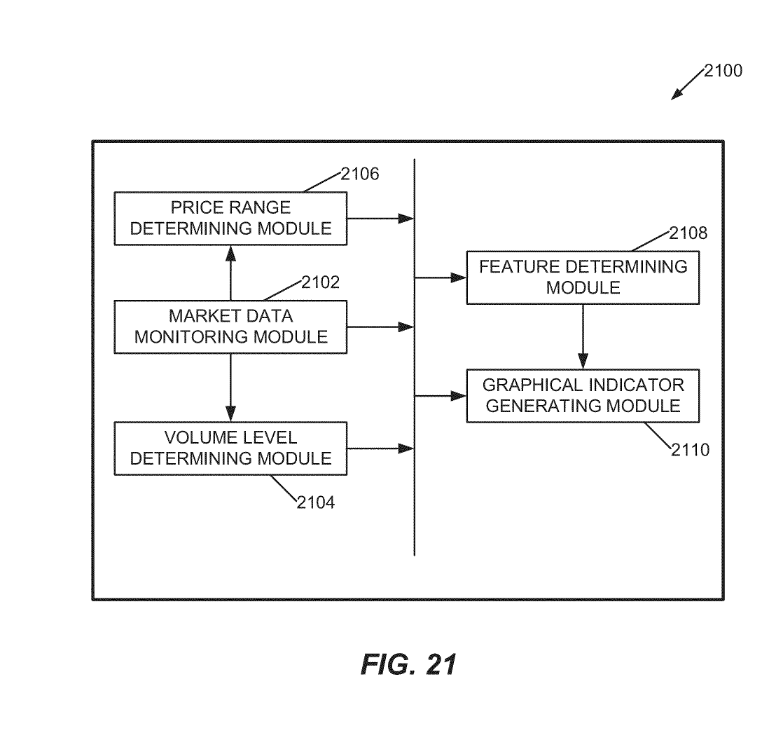

FIG. 21 is a block diagram of an example trading interface module 2100 that may implement and/or execute the example method 1900 of FIG. 19 and/or the example method 2000 of FIG. 20. In some examples, the trading interface module 2100 is implemented as part of the example trading device 210, the example trading device 210, the example computing device 300 and/or any other device. The example trading interface module 2100 includes a market data monitoring module 2102, a volume level determining module 2104, a price range determining module 2106, a feature determining module 2108 and a graphical indicator generating module 2110.

The example trading interface module 2100 is in communication with an electronic exchange such as, for example, the electronic exchange 130 of FIG. 1, the electronic exchange 230a of FIG. 2, the electronic exchange 230n of FIG. 2 and/or any other electronic exchange. The example market data monitoring module 2102 receives, monitors, organizes and/or analyzes market data from the electronic exchange. For example, the example market data monitoring module 2102 monitors a volume of trades of a tradeable object and a price of the tradeable object. In some examples, the market data monitoring module 2102 determines a rate of change and/or an amount of change of the price over a period of time or relative to one or more previously detected prices. In some examples, the market data monitoring module 2102 determines a direction of change of the price. For example, the market data monitoring module 2102 determines if the price is increasing, decreasing or substantially constant.

In some examples, the volume level determining module 2104 determines a volume level of trades of the tradeable object based on the volume of trades. In some examples, the volume level is a percentile of the volume of trades relative to previously detected volumes. In some examples, the volume level is a difference between the volume and a median volume. In some examples, the volume level determining module 2104 calculates the median volume based on volumes detected over a period of time via the market data monitoring module.

In some examples, the example price range determining module 2106 determines a price range over which a graphical indicator is to indicate a trend between the price and the volume of the tradeable object. In some examples, the price range is a given number of ticks from a current price of the tradeable object determined via the market data monitoring module 2102. Some examples do not include the example price range determining module 2106.

The example feature determining module 2108 determines which features and/or characteristics are to be included in the graphical indicator to indicate a trend between the volume and the price of the tradeable object. In some examples, the feature determining module 2108 determines one or more colors (e.g., in a color gradient), line patterns and/or fill patterns of the graphical indicator based on the volume levels of trades of the tradeable object. In some examples, the feature determining module 2108 determines a shape, size and/or orientation of the graphical indicator based on the price of the tradeable object. For example, the feature determining module 2108 may determine a length of the graphical indicator based on a rate of change of the price. In some examples, the feature determining module 2108 determines an orientation of the graphical indicator based on the direction of change of the price (e.g., an increase or a decrease in the price).

The example graphical indicator generating module 2110 generates the graphical indicator based on the features and/or characteristics determined by the example feature determining module 2108. In some examples, the graphical indicator generating module 2110 generates the graphical indicator within a trading interface that is to be used to execute trades on the electronic exchange. In some examples, the trading interface includes market data (e.g., prices or price levels, volumes, ask quantities, bid quantities, and/or other information) related to the tradeable object. In some examples, the graphical indicator generating module overlays the prices and/or other information over the graphical indicator.

Some of the described figures depict example block diagrams, systems, and/or flow diagrams representative of methods that may be used to implement all or part of certain embodiments. One or more of the components, elements, cells, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, cells, and/or functionality may be changed and/or some of the components, elements, cells, and/or functionality described may be changed, eliminated, sub-divided, or combined. Additionally, any or all of the components, elements, cells, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method, comprising:
determining, by a computing device, a first volume of trades of a tradeable object;
determining, by the computing device, a first direction of a change of a price of the tradeable object; and
generating, by the computing device, a graphical indicator, wherein the graphical indicator is based on the first volume and the first direction of the change of the price and is configured to visually indicate a first level of volume of the tradeable object associated with the first direction of the change of the price; and
displaying the graphical indicator with respect to a trading interface including market data related to the tradeable object, wherein the graphical indicator overlaps a value column of the trading interface.

2. The method of claim 1 further comprising:
determining, by the computing device, the first level of volume based on a difference between the first volume and a median volume of trades of the tradeable object over a period of time.

3. The method of claim 2 further comprising:
determining, by the computing device, a second volume of trades of the tradeable object;
updating, by the computing device, the median volume based on the second volume; and
updating, by the computing device, the graphical indicator based on the second volume and the median volume.

4. The method of claim 1 further comprising:
determining, by the computing device, the first level of volume based on the first volume;
determining, by the computing device, a second volume of trades of the tradeable object;
determining, by the computing device, a second level of volume based on the second volume; and
updating, by the computing device, the graphical indicator based on the second level of volume to indicate a direction of change between the first level of volume and the second level of volume.

5. The method of claim 4, wherein updating the graphical indicator comprises:
updating a color of a first portion of the graphical indicator based on the first level of volume associated with the first volume; and
updating a color of a second portion of the graphical indicator based on a second level of volume associated with the second volume.

6. The method of claim 1 further comprising:
determining, by the computing device, a rate of change of the price; and
updating, by the computing device, a size of the graphical indicator based on the rate of change.

7. The method of claim 1, wherein generating the graphical indicator comprises generating an arrow to point in a direction associated with the first direction of the change of the price.

8. The method of claim 1, wherein determining the first volume comprises determining a volume of trades of the tradeable object over a period of time.

9. The method of claim 1, wherein determining the first volume comprises determining a volume of trades of the tradeable object within a price range.

10. The method of claim 1, wherein generating the graphical indicator comprises:
generating the trading interface; and
generating the graphical indicator within the trading interface.

11. A tangible computer readable storage medium comprising instructions that, when executed, cause a computing device to at least:
monitor a volume of trades of a tradeable object;
monitor a price of the tradeable object;
detect a change of the price of the tradeable object; and
update a graphical indicator based on the volume and the change of the price to visually indicate a relationship between the volume and the change of the price; and
display the graphical indicator with respect to a trading interface including market data related to trades of the tradeable object.

12. The tangible computer readable storage medium as described in claim 11 wherein the instructions, when executed, update the graphical indicator by changing a color of the graphical indicator.

13. The tangible computer readable storage medium as described in claim 11, wherein the instructions, when executed, enable the trading interface to be used to execute trades via an electronic exchange.

14. The tangible computer readable storage medium as described in claim 11, wherein the instructions, when executed, update the graphical indicator by changing a size of the graphical indicator.

15. The tangible computer readable storage medium as described in claim 11, further comprising instructions that, when executed, cause the computing device to determine if the price has increased or decreased during a period of time.

16. The tangible computer readable storage medium as described in claim 15, wherein the instructions, when executed, update the graphical indicator by updating an orientation of the graphical indicator based on if the price has increased or decreased during the period of time.

17. A method, comprising:
displaying price levels of a tradeable object on a trading interface to be used to execute trades via an electronic exchange;
monitoring a price of the tradeable object;
monitoring a volume of trades of the tradeable object; and
displaying a graphical indicator on the trading interface indicating a trend between the volume of trades and the price.

18. The method of claim 17, wherein displaying the graphical indicator comprises displaying a graphical indicator indicating a direction of change of the price relative to an order of the price levels displayed on the trading interface.

19. The method of claim 18 further comprising periodically updating a feature of the graphical indicator based on the volume.

20. The method of claim 17, further comprising updating the graphical indicator based on the volume over a first period of time relative to a median volume over a second period of time greater than the first period of time.
